(19) United States
(12) Patent Application Publication
(10) Pub. No.: US 2002/0145397 A1
(43) Pub. Date: Oct. 10, 2002

(54) Electronically commutated electric motor

(76) Inventors: Thomas Mohr, Buehlertal (DE); Stefan Koch, Achern (DE)

Correspondence Address: STRIKER, STRIKER & STENBY, 103 East Neck Road, Huntingon, NY, 11743, US

(21) Appl. No.: 10/105,827

(22) Filed: Mar. 25, 2002

(30) Foreign Application Priority Data
Apr. 6, 2001 (DE) 101 17 252.4

(51) Int. Cl. H02P 1/00

(52) U.S. Cl. 318/138

(57) ABSTRACT

An electronically commutated electric motor, has a rotor energized by permanent magnets; a stator provided with windings; a control electronic unit which supplies the windings of the stator with current in a low frequency cycle depending on a detected position of the rotor; commutator detecting means which detect the position of the rotor, the control electronic unit attenuating individual current supply periods of the windings to be supplied with current per unit time.

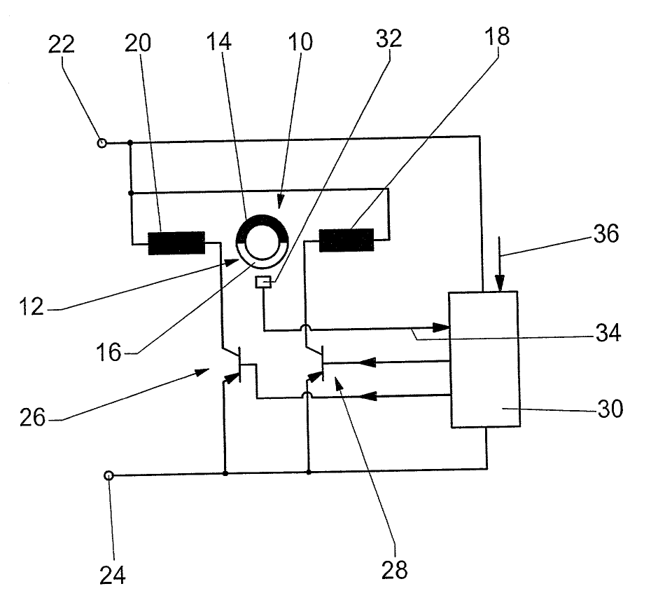

### BACKGROUND OF THE INVENTION

The present invention relates to an electronically commutated electric motor.

Known electric motors with electronic commutation are composed of a rotor provided with permanent magnets, and a stator provided with electrical windings. In motor vehicles they are used for ventilation/air conditioning as well as for pumping and adjusting drives. Electric current flows through the windings of the stator in a sequence provided by the used winding circuitry. Thereby a magnetic rotary field resulting from the current flow is formed at each time point. A torque is produced from the deviating angular position of the permanent rotor field relative to the stator field and thereby the latter rotates in direction of the stator field. The constant rotary motion is produced by a targeted control of the windings of the stator. The type of controlling determines the rotary direction and the rotary speed is produced from the loading moment and the motor torque, depending on the value of the supplied current.

The electronically commutated electric motor is supplied with power from a direct current circuit, and the control of the winding of the stator is performed through electronic power switches. They are controlled in dependence on the position of the rotor by a control electronic system which includes as a rule a microcontroller. A commutation detection which as a rule includes a Hall sensor determines the actual position of the rotor and the permanent magnets connected to it. Such electric motors are described for example in “Kraftfahrtechnischen Taschenbuch/Bosch, 23rd edition, Viehweg Verlag Braunschweig, page 134. A sensorless method for detection of the position of the rotor is also known, in which the voltage induced during the rotation of the rotor is evaluated in a winding which is not instantaneously supplied with current by the power electronic circuit.

For regulation of the known electric motors, the supply voltage is pulsed with a high frequency of approximately 15,000 Hz and the thusly produced voltage pulses are modulated with respect to their pulse width. The high frequency oscillations with a frequency over an audible region can cause disturbances of neighboring communication systems in vehicle, since they are located with their frequency and amplitude in their usable region and can be received directly by the sensor of the communication system, the antenna, through the antenna conductor. Therefore measures for electromagnetic compatibility (ENV) and ignition noise are to be taken. For smoothing the supply voltage, mainly high capacities are provided in accordance with national and international standards such as:

DIN 40839 part 1, ISO 7637-0/-1/-2

DIN 4039 part 3, ISO 7637-3

DIN 40839 part 4, ISO 11451/11452, ISO/TR10605,

as well as the requirements of the motor vehicle manufacturers.

German patent document DE 2949947 C2 discloses a circuit arrangement for control and regulation of a collectorless electric motor with a permanent magnet rotor. A stator of the electric motor has two windings through which a current can flow. Electric current flows through one of the windings for increasing the torque only during the starting phase and an operational condition, in which the rotary speed of the electric motor falls below a predetermined value. Individual current supply periods of the windings to be supplied with current are not attenuated.

### SUMMARY OF THE INVENTION

Accordingly, it is an object of the present invention to provide an electronically commutated electric motor which avoids the disadvantages of the prior art.

More particularly in accordance with the present invention an electric motor is provided in which the control electronic system for regulating the electric motor attenuates individual current supply periods of the windings of the stator to be supplied with current per time unit.

With the repeat frequency of the omitted current supply periods which amount in a useful region of the electric motor with 300 revolutions per minute and a commutating frequency of approximately 400 Hz to approximately 2.5 milliseconds, the average current flow through a winding per unit time is reduced without turning off of the winding completely. Thereby the rotary speeds of the electric motor with a predetermined loading motor can be adjusted in a desired manner. Because of the mass inertia of the rotor, the electric motor runs further with a reduced rotary speed uniformly, despite the nonuniform current supply of the individual winding. A high-frequency pulsing of the current and thereby required EVM features can be dispensed with.

It is advantageous with consideration of ohmic losses, to smooth the voltage peaks on switch flanks produced by induction, by switching off the current with ohmic resistors. This is possible without damages because of the relatively low power and not frequent occurrences. In addition, the absence of interference suppressing circuits which would be required in a high frequency region increases the reliability, since a failure or a post action of the interference suppressing circuit which often is not considered by the user, is excluded.

The highest commutating frequency is produced from the highest operational rotary speed. It is substantially lower than the conventional pulse frequency of the supply voltage approximately by factor 40. At the same time the principle in the electric motor is maintained in accordance with which the position of the rotary is measured and from it the actual commutating time point is determined.

In order to guarantee the synchronism of the electric motor, the attenuated current supply periods are distributed in an advantageous manner uniformly over the regulating time so that each n-th current supply period is wasted, for example each 10th. Also, n can be any integral number greater than one. In a multi-phase, in particular two-phase electric motor the individual current supply periods must be attenuated alterantingly on the individual windings to be current supplied in a distributed way. Thereby alterantingly one of the both switching members is unloaded so that the same thermal load and compensated wear are provided. Furthermore, with reduced rotary speed, a symmetrical rotary field and a uniform temperature distribution is obtained.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing an electronically commutated electric motor.

### DESCRIPTION OF THE PREFERRED EMBODIMENT

An electronically commutated direct current motor is identified with reference numeral 1 and has a rotor 12 with permanent magnets. They form a north pole 14 and a south pole 16 diametrically to the rotary axis. Two windings 18 and 20 are located in a stator of the electric motor 10. They are connected to a direct voltage source between a positive current terminal 22 and a negative current terminal 24. When a current supply is provided, a magnetic field is formed in an axial direction of the windings 18, 20.

The windings 18, 20 are controlled alternatingly by a control electronic unit 30 via power switches 26 and 28. The control electronic unit 30 evaluates two input signals 34 and 36 with a micro controller. The position of the rotor 12 and thereby the position of the both poles 14 and 16 is determined from the initial signal 34 which is produced by a commutation detection in form of a Hall sensor 32. Therefore the control electronic unit determines the commutating condition required for operation of the motor. Simultaneously the speed change of the input signal 34 provides information about the instantaneous rotary speed of the rotor 12.

This actual rotary speed is compared by the control electronic unit 30 with the second input signal 34 which provides the desired nominal speed. When these rotary speeds coincides, the power switches 26, 28 are controlled in correspondence with the determined commutation condition and without changes of the current supply periods. A difference between the nominal rotary speed and the actual rotary speed is compensated by the control electronic unit with a corresponding increase or reduction of the current supply periods of the current supplied windings 18, 20.

Individual current supply periods are attenuated alternatingly on the individual current supplied windings 18, 20 in a distributed way, from symmetry reasons with respect to the thermal loading for the power switches 26, 28 and the windings 18, 20 as well as the torque formation.

It will be understood that each of the elements described above, or two or more together, may also find a useful application in other types of constructions differing from the types described above.

While the invention has been illustrated and described as embodied in electronically commutated electric motor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An electronically commutated electric motor, comprising a rotor energized by permanent magnets; a stator provided with windings; a control electronic unit which supplies said windings of said stator with current in a low frequency cycle depending on a detected position of said rotor; commutator detecting means which detect the position of said rotor, said control electronic unit attenuating individual current supply periods of said windings to be supplied with current per unit time.

2. An electronically commutated electric motor as defined in claim 1, wherein said control electronic unit operates so that each n-th current period is wasted, wherein n is an integral number greater than one.

3. An electronically commutated electric motor as defined in claim 2, wherein said control electronic unit operates so that individual current supply periods of the windings to be supplied with current are alternatingly attenuated on said windings in a distributed manner.

4. An electronically commutated electric motor as defined in claim 1, wherein said control electronic unit operates so that a switching flank during switching off of a current is smoothed by an ohmic resistance of switching members.
